(19) United States
(12) Patent Application Publication
(10) Pub. No.: US 2022/0142119 A1
(43) Pub. Date: May 12, 2022

(54) ELEVATED ANIMAL FEEDER WITH ANTI-CLIMB BASE

(71) Applicant: Hiram Joseph Coffey, Akron, OH (US)

(72) Inventor: Hiram Joseph Coffey, Akron, OH (US)

(21) Appl. No.: 17/520,841

(22) Filed: Nov. 8, 2021

Related U.S. Application Data
(60) Provisional application No. 63/111,472, filed on Nov. 9, 2020.

(51) Int. Cl. A01K 5/01; A01K 39/01

(52) U.S. Cl. CPC A01K 5/01; A01K 39/0113

(57) ABSTRACT

Provided are an animal feeder and method of limiting access to animal feed supported by an animal feeder. The animal feeder can include a base that defines an internal passage sized to at least partially receive a stake driven into a ground surface to support the animal feeder in an upright orientation. The base comprises an anti-climb feature that interferes with efforts by an animal to climb the base from the ground surface. A feed surface cooperates with the base, to be supported by the base at an elevation vertically above the ground surface with the animal feeder in the upright orientation. At least a portion of the base includes an anti-climb feature such as a smooth exterior surface, and includes a dimension that is not able to be gripped by the animal to prevent the animal from climbing the base from the ground surface to the feed surface.

### BACKGROUND OF THE INVENTION

### 1. Field of the Invention

This application relates generally to an animal feeder and, more specifically, to an animal feeder including a feed surface that is to be supported at an elevation above ground by a base with an anti-climb feature that interferes with an ability of an animal to climb from the ground to the feed surface.

### 2. Description of Related Art

Conventional animal feeders are commonly fastened to wooden posts that are driven into the ground. Even though such feeders are elevated above the ground, varmints such as raccoons, mice, opossums, skunks, squirrels, chipmunks and similar wild animals can dig their claws into the wood, allowing them to climb the wooden posts and access food supported by the feeder. Upon reaching the food supported by the feeder, such varmints will often eat or scatter all of the food, frustrating efforts to feed a targeted species with the food.

### BRIEF SUMMARY OF THE INVENTION

According to one aspect, the subject application involves an animal feeder comprising a base with an anti-climb feature, and a feed surface to be supported by the base for supporting a food block or other animal food at an elevation vertically above the ground. The anti-climb feature interferes with the ability of varmints to climb the base and reach the feed surface, thereby protecting the food from such varmints, and preserving the food for target animals that can reach the food without climbing (e.g., deer, elk, birds, etc.).

According to some aspects, the subject application involves an animal feeder that comprises a base that defines an internal passage sized to at least partially receive a stake driven into a ground surface. Cooperation between the stake and the base supports the animal feeder in an upright orientation. The base comprises an anti-climb feature that interferes with efforts by an animal to climb the base from the ground surface. A feed surface cooperates with the base, to be supported by the base at an elevation vertically above the ground surface with the animal feeder in the upright orientation. As an example of the anti-climb surface, at least a portion of an exterior surface of the base can be smooth, and comprise a dimension that is not able to be gripped by the animal with sufficient force to allow the animal to lift its own weight up the base, thereby preventing the animal from climbing the base from the ground surface to the feed surface.

According to some aspects, the subject application involves a method of limiting access to animal feed supported by an animal feeder. The method comprises driving a stake into a ground surface, leaving at least a portion of the stake protruding from the ground surface. A base comprising an anti-climb feature is coupled to the portion of the stake protruding from the ground surface by placing a generally-cylindrical tube of the base over the portion of the stake protruding from the ground surface. The base fully installed on, and coupled to the stake supports a feed surface at least thirty-six (36) inches above the ground surface. Animal feed is placed on the feed surface, protected from a varmint and maintained for an intended animal species that can each from the feed surface while standing on the ground surface surrounding the animal feeder.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF SEVERAL VIEWS OF THE DRAWING

The invention may take physical form in certain parts and arrangement of parts, embodiments of which will be described in detail in this specification and illustrated in the accompanying drawings which form a part hereof and wherein:

FIG. 1 is a partially-exploded, front view of an illustrative embodiment of an animal feeder including a base with climb protection supporting a feed surface for supporting animal food at an elevation vertically above a ground surface;

FIG. 2 is a top view of an illustrative embodiment of a feed surface to be supported at an elevation vertically above a ground by a base with an anti-climb feature, the feed surface defining at least one, or a plurality of apertures that drain a liquid from atop the feed surface;

FIG. 3 is a side view of an illustrative embodiment of a feed surface supported at an elevation vertically above a ground by a base with an anti-climb feature, the feed surface comprising a border wall, and a roof that shields a portion of the feed surface and optionally food on the feed surface from rain and/or direct sunlight;

FIG. 4 is a front view of an illustrative embodiment of a feed surface supported at an elevation vertically above a ground by a base with an anti-climb feature, the feed surface comprising a border wall, and a roof that shields a portion of the feed surface and optionally food on the feed surface from rain and/or direct sunlight;

FIG. 5 is a perspective view of an illustrative embodiment of an anti-climb feature of a base that interferes with an ability of an animal to climb the base to reach a feed surface, or animal food on the feed surface, supported by the base; and

FIG. 6 is a flow diagram schematically depicting an illustrative embodiment of a process of limiting access to animal feed supported by an animal feeder in accordance with aspects of the present disclosure.

### DETAILED DESCRIPTION OF THE INVENTION

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

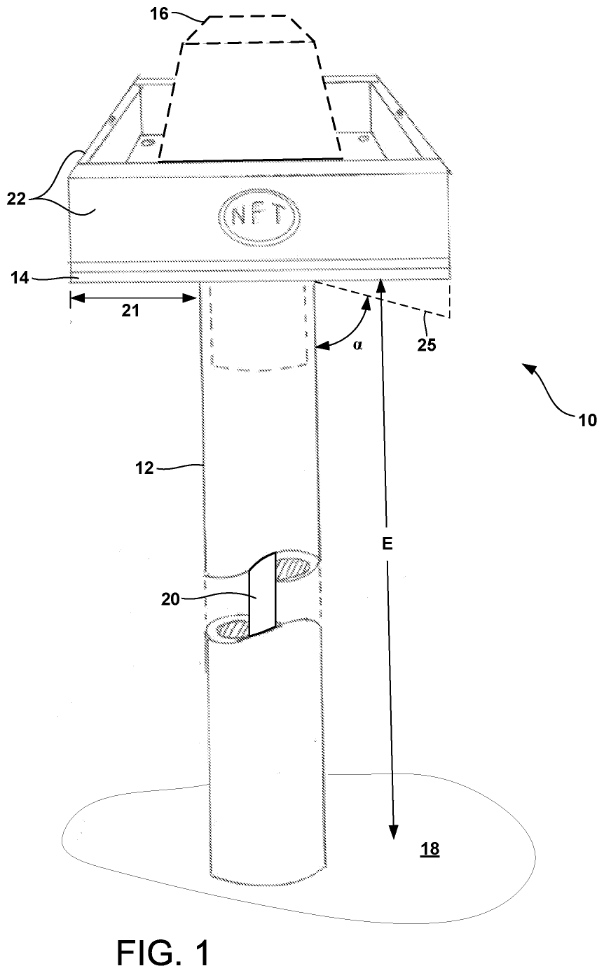

With reference to the drawings, FIG. 1 shows an illustrative embodiment of an animal feeder 10 including a base 12 (partially cutaway) with climb protection supporting a feed surface 14. The feed surface 14 can be formed from a plastic material such as the polymeric material polyvinyl chloride (“PVC”), for example, a metal or metal alloy, or any other material, and supports animal food 16 at an elevation E vertically above a ground surface 18. Supported at such an elevation, the food 16 is accessible to tall animals such as deer, elk, etc., birds that fly to the food 16 from above, or a combination thereof. However, varmints that are short, such as raccoons, mice, opossums, skunks, squirrels, chipmunks and similar wild animals, for example, are unable to reach the feed surface 14, even while standing on their hind legs. For example, the base 12 can have a length suitable to support the feed surface 14 at an elevation at least thirty six (36 in.) inches above the ground surface 18, at least thirty eight (38 in.) inches above the ground surface 18, at least forty (40 in.) inches above the ground surface 18, at least forty two (42 in.) inches above the ground surface 18, at least forty four (44 in.) inches above the ground surface 18, and so on.

The base 12 can include a surface or a plurality of surfaces that define an interior passage that extends along a length of the base 12. For example, the base 12 can include a tube formed from a plastic material such as polyvinyl chloride (“PVC”), a metal or metal alloy, or any other material that is resistant to being pierced by the claws of varmints to an extent that would allow the varmints to climb up the base 12 to reach the feed surface 14. The exterior surface of the base 12 can also be smooth, to limit the ability of varmints to get a firm enough of a grip on the base 12 to climb the base 12 up to the feed surface 14.

In addition to, or in lieu of being pierce resistant, the base can have one or more dimensions, or be constructed to include surfaces that are not able to be gripped by varmints. For example, a raccoon may be able to grip (e.g., wrap digits on their paws substantially around) a pipe having an arcuate exterior surface with a small radius of curvature (e.g., a one (1 in.) inch outside diameter). In such a way, the raccoon can climb paw-over-paw up such a pipe to reach a feed surface supported by the pipe. In contrast, some embodiments of the base 12 can include an outside diameter that is too large to be gripped by a varmint. For example, the embodiments of the base 12 that include a tube defining an interior passage can have a radius of curvature large enough that varmints are unable to grip the tube sufficiently to climb the base 12 to reach the feed surface 14. According to some embodiments, the tube can have an outside diameter of at least two (2 in.) inches, at least three (3 in.) inches, at least four (4 in.) inches, at least five (5 in.) inches, at least six (6 in.) inches, and so on.

According to some embodiments, the base 12 can be constructed with a cross-sectional shape that varmints of concern are unable to grasp onto surfaces with sufficient strength to climb the base 12 and reach the feed surface 14. For example, the cross-sectional shape could be star-shaped, or any other shape that varmints are unable to climb. According to the illustrative embodiment shown in FIG. 5, the base 12 can include a generally-cylindrical tube 15 defining a generally-cylindrical internal passage 17. The term “generally” is used herein to describe a structure that extends to a greater extent in a direction parallel to a major axis of the structure, than in a direction transverse to the major axis of the structure. With regard to the embodiment shown in FIG. 5, the tube 15 extends in an axial direction to a greater extent than the tube extends in the radial direction (e.g., the tube 15 has a greater length than a diameter). The tube 15 forms a central region from which a plurality of protruding arms 19 extend. Any number of arms 19 suitable to interfere with the ability of varmints or any other relatively-small animals to climb the base 12 can be provided.

Accordingly, the base 12 equipped with an anti-climb feature can interfere with the ability of varmints (e.g., animals having a vertical reach of up to thirty (30 in.) inches when standing on their hind legs) to reach the feed surface 14. The varmints can be prevented from climbing the base 12 without the application or use of a lubricant, chemical deterrent (e.g., repellant spray) in combination with the base animal feeder. In other words, the base 12 can optionally be devoid of a grease, silicone spray, or other coating that reduces the coefficient of friction between the base 12 and the varmints' claws, and optionally be devoid of other repellants with a composition that would otherwise repel the varmints.

To facilitate installation, the interior passage defined by some embodiments of the base 12 has a suitable dimension to receive a stake 20. For example, a stake can be formed from a metal, metal alloy, wood, polymeric material, or any other material that can be driven into the ground 18 using a sledge hammer, fence post driver, or the like. The stake can optionally have a point at an end that is to be driven into the ground. However, the relatively-small cross-sectional area of the stake 20 compared to the relatively-large cross-sectional area of the tube or other base 12, requires less force to insert the stake 20 into the ground surface 18 than the force required to drive the base 12 into the ground surface 18.

According to the embodiment illustrated in FIG. 1, the food 16 can be formed into a “block” that can be cubical, trapezoidal, or any other shape forming a monolithic structure that rests within a perimeter of the feed surface 14. According to some embodiments, the food 16 block can comprise at least one of: corn, whole grains or other nutrition source; a fat source; a vitamin source; and a binder such as molasses-based material that attracts a target species such as deer, elk, etc. However, other embodiments of the food 16 can include loose food such as corn or other whole grains.

Some embodiments of the feed surface 14 include a rectangular or other-shaped platform that extends axially outward, beyond an exterior surface of the base 12. For example, all four lateral sides of the feed surface 14 can be laterally offset, beyond the perimeter of the base 12 to form an overhang 21. According to some embodiments, an underside 25 of the feed surface 14 can include a tapered, arcuate, or other region that forms an acute angle α (FIG. 1) relative to the base 12, or a shield attachment that couples to the feed surface and/or base 12 to interfere with an ability of the varmint to climb outward (in a radial direction relative to the base 12), toward and beyond a peripheral side wall 22. Thus, even if a varmint were to climb the base 12, the varmint would not be able to climb out, around a lateral periphery of the feed surface 14 to access a top of the feed surface 14 where the food 16 is supported. At least one, and optionally a plurality of side walls 22 can extend upward from a perimeter of the feed surface 14 to contain or otherwise surround a portion of the food 16. According to some embodiments, one of, a plurality of, or optionally all of the side walls 22 can be tapered outward, as shown in FIG. 3, for example. According to such embodiments, an upper region 29 of the one or more tapered side walls 22 can extend further away from a central region of the feed surface 14 than a lower region 35 of the one or more tapered side walls 22.

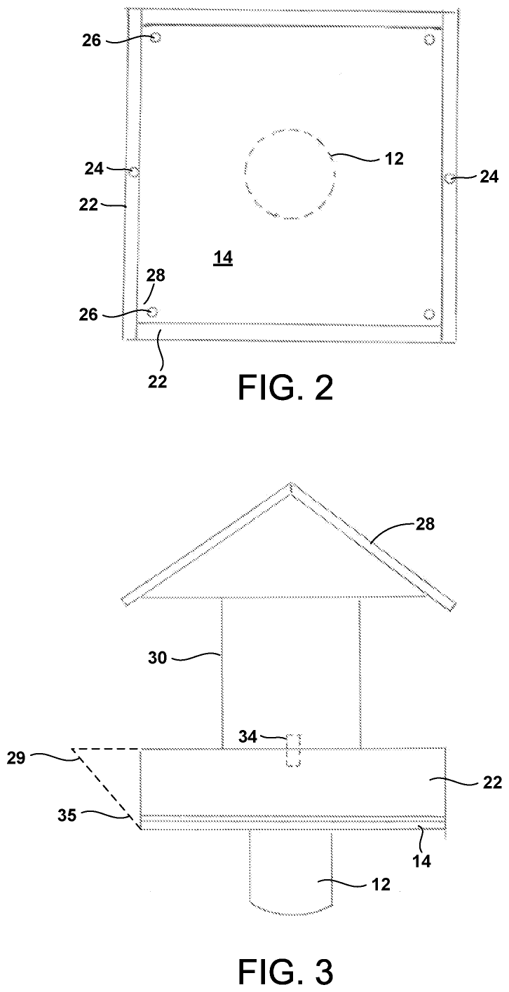

FIG. 2 is a top view of an illustrative embodiment of the feed surface 14 that can be supported by the base 12 (shown in hidden lines) vertically above the ground 18. According to the illustrated embodiment, the feed surface 14 defines at least one, and optionally a plurality of apertures 26 that drain a liquid from atop the feed surface. For example, apertures 26 can be formed adjacent to corner regions 28 of the feed surface 14. Water that collects on the feed surface 14 can drain through the apertures 26.

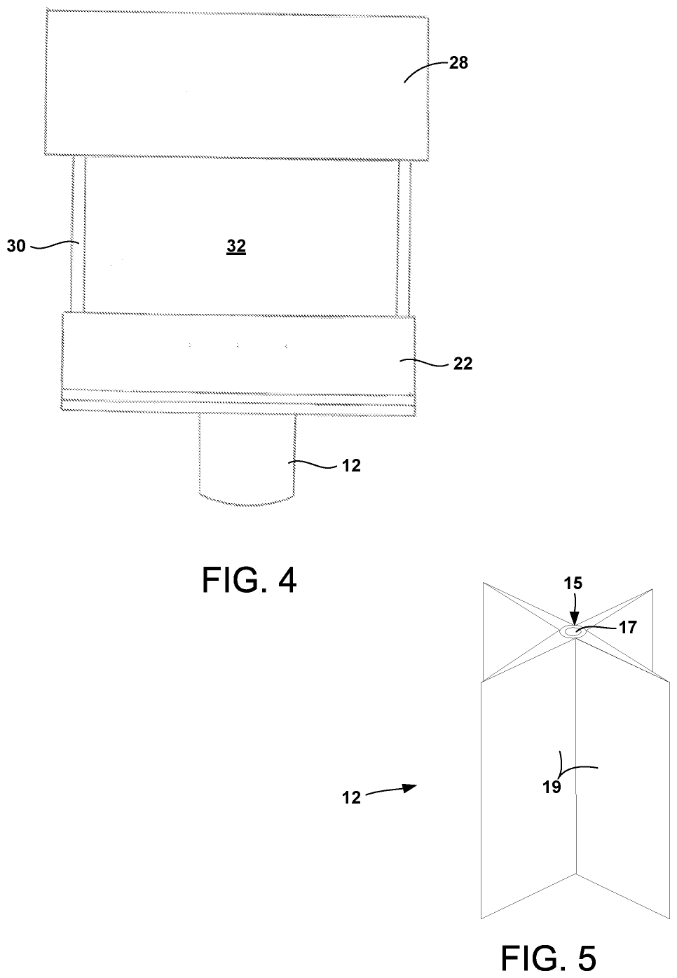

Some embodiments of the animal feeder 10 can also optionally include a roof 28, an example of which is shown in FIG. 3. The roof 28 can be supported by one, or a plurality of uprights 30. For example, an upright 30 can optionally be arranged on opposite sides of the feed surface 14, as shown in FIG. 4, and extend upwardly, to an elevation vertically above the elevation E of the feed surface 14. According to such embodiments, opposing side walls 22 can define apertures 24 (FIG. 2) that can receive mounting posts 34 (shown in hidden lines in FIG. 3) extending between the opposing side walls 22 and the respective uprights 30. The mounting posts 34 can be formed as part of the uprights 30, or be separate pegs that are inserted into the apertures 24, with a protruding portion received by apertures formed in an underside of the uprights 30. According to other embodiments, the mounting posts 34 can be formed as part of the opposing side walls 22, allowing an aperture formed in the underside of the uprights 30 to be placed over the protruding portions of the mounting posts 34. According to such embodiments, the roof 28 can be added as an aftermarket addition to the animal feeder 10, such as after the animal feeder 10 is installed in the field. The elevation of the roof 28 above the feed surface 14 forms a space 32 sufficient to allow deer, elk or other animal to access the food 16 between the roof 28 and the feed surface 14, yet shield the food from rain and other elements.

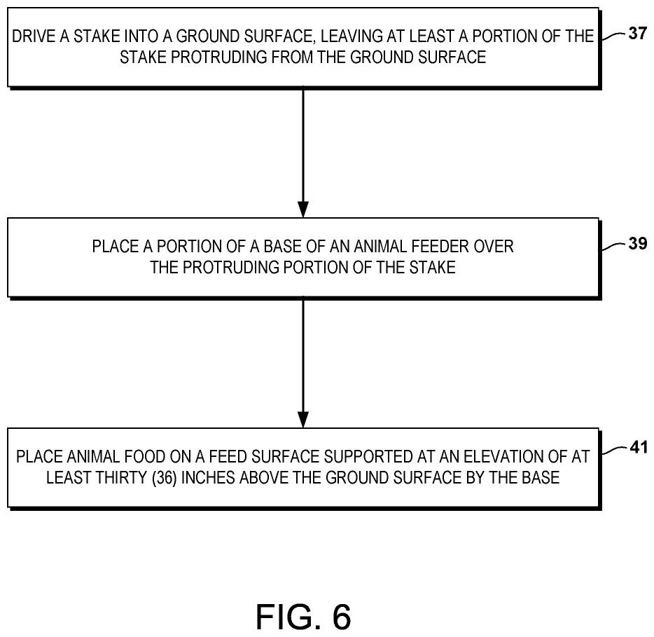

In use, the present technology can interfere with the ability of varmints to reach the animal food 16 supported on the feed surface 14 by climbing the base 12. As illustrated by the flow diagram of FIG. 6, a stake is driven at least partially into the ground surface 18 at block 37. A sledge hammer, fence post driver, or other device can be used to pound a pointed end of the stake into the ground surface 18, leaving a blunt end of the stake protruding out of the ground surface 18. For example, at least twelve (12) inches, at least eighteen (18) inches, at least twenty-four (24) inches, at least thirty (30) inches, or other extent of the stake can be left protruding from the ground surface 18.

At block 39, the base 12 comprising the anti-climb feature is coupled to the portion of the stake 20 protruding from the ground surface 18. For example, the generally-cylindrical tube of some embodiments of the base 12 can be placed over the portion of the stake 20 protruding from the ground surface 18. According to such embodiments, the protruding portion of the stake 20 is received within an interior passage defined by the tube of the base 12. For some embodiments, the base 12 so installed on the protruding portion of the stake 20 supports the feed surface 14 at least thirty-six (36) inches, or other desired height, above the ground surface 18. A distal portion of the base 12 can include a first coupler portion that engages a portion of a second coupler portion provided to the feed surface 14, thereby coupling the feed surface 14 to the base 12. According to alternate embodiments, the feed surface 14 and the base 12 can be integrally formed as a monolithic structure, or the feed surface 14 can be bonded or otherwise coupled by one or more fasteners to the base 12.

At block 41, the animal feed 16 is placed on the feed surface 14, to be supported at a height (e.g., greater than thirty-six (36) inches above the ground surface 18) above which the varmints can reach while standing on their hind legs. Due at least in part to the anti-climb feature of the base 12, varmints are prevented from climbing the base 12 to reach the animal food 16 supported by the feed surface 14. According to some embodiments, one or a plurality of uprights 30 can be coupled to the feed surface 14. The upright(s) 30 can be separable from, and independently installable on the feed surface 14 or other structure coupled to the feed surface 34. The roof 28 can be installed on the one or more uprights 30, protecting at least a portion of the animal food 16 on the feed surface 14 from the environmental elements such as rain, direct sunlight, etc.

Illustrative embodiments have been described, hereinabove. It will be apparent to those skilled in the art that the above devices and methods may incorporate changes and modifications without departing from the general scope of this invention. It is intended to include all such modifications and alterations within the scope of the present invention. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An animal feeder comprising:
a base that defines an internal passage sized to at least partially receive a stake driven into a ground surface to support the animal feeder in an upright orientation, wherein the base comprises an anti-climb feature that interferes with efforts by an animal to climb the base from the ground surface; and
a feed surface that cooperates with the base, to be supported by the base at an elevation vertically above the ground surface with the animal feeder in the upright orientation, wherein at least a portion of an exterior surface of the base is smooth, and comprises a dimension that is not able to be gripped by the animal to prevent the animal from climbing the base from the ground surface to the feed surface.

2. The animal feeder of claim 1, wherein the base comprises a tube formed from a polymeric material having an outside diameter of at least three (3 in.) inches.

3. The animal feeder of claim 2, wherein the tube comprises a length suitable to support the feed surface 14 at an elevation at least thirty six (36 in.) inches above the ground surface 18.

4. The animal feeder of claim 2, wherein the tube comprises a length suitable to support the feed surface 14 at an elevation at least forty two (42 in.) inches above the ground surface 18.

5. The animal feeder of claim 1, wherein the base comprises a tube forming a single support member that is to extend between the feed surface and the ground surface with the animal feeder installed in the upright orientation.

6. The animal feeder of claim 5, wherein the tube comprises a generally-cylindrical shape, and an externally-exposed surface formed from a polymeric material having an outside diameter of at least three (3) inches.

7. The animal feeder of claim 6, wherein the tube defines the internal passage, which is sized to be placed over a portion of the stake protruding upward, out of the ground surface.

8. The animal feeder of claim 1, wherein the feed surface comprises a platform that extends axially outward, beyond an exterior surface of the base to form an overhang.

9. The animal feeder of claim 8, wherein the feed surface comprises a plurality of lateral sides that, when the feed surface is supported by the base, are laterally offset, beyond a perimeter of the base.

10. The animal feeder of claim 9, wherein at least one of the plurality of side walls extends upward from a perimeter of the feed surface to contain or otherwise surround a portion of food that is to be supported by the feed surface.

11. The animal feeder of claim 1 further comprising:
an upright that extends above an elevation of the feed surface; and
a roof that cooperates with a portion of the upright to be supported at an elevation vertically above the feed surface, to shield at least a portion of food that is to be supported by the feed surface from an environmental element.

12. A method of limiting access to animal feed supported by an animal feeder, the method comprising:
driving a stake into a ground surface, leaving at least a portion of the stake protruding from the ground surface;
coupling a base comprising an anti-climb feature to the portion of the stake protruding from the ground surface by placing a generally-cylindrical tube of the base over the portion of the stake protruding from the ground surface such that the base supports a feed surface at least thirty-six (36) inches above the ground surface; and
placing the animal feed on the feed surface.
